(19) United States
(12) Patent Application Publication
(10) Pub. No.: US 2005/0073947 A1
(43) Pub. Date: Apr. 7, 2005

(54) Channel estimator for a receiver and method of operation thereof

(75) Inventors: Sourav R. Dey, Cambridge, MA (US); David P. Magee, Plano, TX (US); Srinath Hosur, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/677,605

(22) Filed: Oct. 2, 2003

(51) Int. Cl. H04J 1/16

(52) U.S. Cl. 370/208; 370/480

(57) ABSTRACT

For use with an orthogonal frequency division multiplexing (OFDM) receiver, the present invention discloses a channel estimator that employs a training sequence received through a channel. In one embodiment, the channel estimator includes a response assesser and a reducer. The response assesser computes a channel impulse response of the channel in a time-domain based on the training sequence. The reducer, coupled to the response assesser, sets designated taps associated with the channel impulse response to substantially zero.

### TECHNICAL FIELD OF THE INVENTION

The present invention is directed, in general, to wireless communications systems and, more specifically, to an orthogonal frequency division multiplexing (OFDM) channel estimator for a receiver and a method of operating the same.

### BACKGROUND OF THE INVENTION

The use of wireless communications continues to expand with the development of wireless devices and the improvement of wireless communications systems. More users are exchanging information through pagers, cellular telephones and other wireless communications products. Additionally, wireless communications allows users to exchange information in personal and business computing through wireless networks such as a wireless local area network (WLAN). A WLAN provides flexibility and mobility for users by enabling access to computer networks without being tied to a wired network.

Several standards have been established to provide uniformity and consequently growth in the development of wireless networks. One such standard is 802.11, promulgated by the Institute of Electrical and Electronic Engineers (IEEE), which is incorporated herein by reference. IEEE 802.11 is an umbrella standard that encompasses a family of specifications pertaining to WLAN technology. Generally, IEEE 802.11 specifies an over-the-air interface between a wireless client and a base station or between two wireless clients.

Within the IEEE 802.11 family are several specifications covering topics such as different transmission rates, encoding schemes and frequency bands for transmitting data wirelessly. For example, IEEE 802.11(a) is an extension of IEEE 802.11 that specifically addresses WLANs having a data rate up to 54 Mbps at a frequency band of 2.4 GHz. Additionally, IEEE 802.11(a) specifies an orthogonal frequency division multiplexing (OFDM) encoding scheme.

The OFDM system, specified in IEEE 802.11(a), provides a WLAN with data payload communication capabilities of 6, 9, 12, 18, 24, 36, 48 and 54 Mbps. The IEEE 802.11(a) OFDM system uses 52 subcarriers, or subchannels, that are modulated using binary or quadrature phase shift keying (BPSK/QPSK), 16-quadrature amplitude modulation (QAM), or 64-QAM, depending on the data rate. Forward error correction coding (convolutional coding) is used with a coding rate of ½, ⅔, or ¾.

A long training sequence exists in an IEEE 802.11(a) compliant system and can be used for channel estimation. In the frequency-domain, the long training sequence is given as equation1:
X[k]={0,0,0,0,0,0,1,1,−1,−1,1,1,−1,1,−1,1,1,1,1,1,1,−1,−1,1,1,−1,1,−1,1,1,1,1,0,1,−1,−1,1,1,−1,1,−1,1,−1,−1,−1,−1,−1,1,1,−1,−1,1,−1,1,−1,1,1,1,1,0,0,0,0,0} (1)
for −32≦k≦31.

The long training sequence has a zero at the DC zero tone (emphasized in equation 1 as the middle tap k=0) and a guard band of zeros on either side of the 52 excited tones k=[−26,−1] and k=[1,26] (also emphasized in equation 1). Generally, an excited tone will include information and a zero tone, or unexcited tone, does not intentionally include any information. Before the long training sequence is transmitted through a wireless multipath channel, an inverse Fast Fourier Transform (IFFT) of equation 1 is performed thereon and cyclically extended to 80 samples.

A channel estimator receives a distorted version of the long training sequence in a receiver that performs functions such as timing acquisition, a frequency offset, and a Fast Fourier Transform (FFT) of the received long training sequence which has been distorted. Mathematically, the distorted version of the long training sequence in the frequency-domain, Y[k], is:
Y[k]=X[k]H[k]+N[k] (2)
where H[k] is a wireless channel response and N[k] is noise. The long training sequence X[k] is known at the receiver, thus the channel estimator uses the known long training sequence X[k] and the distorted version thereof Y[k] to generate a channel response estimate Ĥ[k] for a receiver. In the time-domain, the wireless multi-path channel is modeled as a time-limited channel impulse response represented by equation 3:

$$h ( t ) = {\sum }_{i = 0}^{L - 1} {a}_{i} δ ( t - {τ}_{i} {T}_{s} ) \qquad ( 3 )$$

where L is the number of multi-path delays, aᵢ is a Rayleigh or Ricean distributed complex tap gain, τᵢ represents a delay of the i^{th} path, and Tₛ is a sampling period. Furthermore, 0<τᵢTₛ<T_{g}, i.e., the entire channel impulse response lies within the guard band. Typically, the delay τᵢ is not an integer such that the channel impulse response does not fall at discrete time samples.

When sampled and converted to discrete time, a discrete-time channel can be interpreted as non-integer discrete time delays. Using continuous time processing of the discrete time signals as an interpretation, h[n] can be viewed as a sampled version of the band-limited interpolation of the time-limited channel impulse response h(t), i.e., sinc convolved over every channel impulse response. Mathematically, the discrete-time channel impulse response simplifies to equation 4.

$$h [ n ] = {\sum }_{i = 0}^{L - 1} {a}_{i} \frac{sin π ( n - {τ}_{i} / {T}_{s} )}{π ( n - {τ}_{i} / {T}_{s} )} \qquad ( 4 )$$

To perform these calculations, the channel estimator is usually implemented in a processor-based system. As with any processor, a tradeoff exists between performance and the million instructions per second (MIPS) available. Though desired, a high-performance channel estimator typically involves complex calculations as herein described which results in an increase in algorithm complexity of a processor. Therefore, a design of a receiver may often require a balance between quality and complexity.

In related U.S. patent application entitled “TRANSMITTER AND RECEIVER FOR USE WITH AN ORTHOGONAL FREQUENCY DIVISION MULTIPLEXING SYSTEM,” Ser. No. ______, which is commonly assigned and filed concurrently with the present application, and is incorporated herein by reference as if reproduced herein in its entirety, an improved OFDM transmitter, communications system and receiver are disclosed. Improvements, however, in balancing quality and complexity of an OFDM receiver may still be desired.

Accordingly, what is needed in the art is a more efficient way to perform channel estimation and, more specifically, a system and method adapted to estimate a response of IEEE 802.11 OFDM channels that may employ less complex processor resources.

### SUMMARY OF THE INVENTION

To address the above-discussed deficiencies of the prior art, the present invention is directed to a channel estimator, for use with an orthogonal frequency division multiplexing (OFDM) receiver, that employs a training sequence received through a channel. In one embodiment, the channel estimator includes a response assesser and a reducer. The response assesser is configured to compute a channel impulse response of the channel in a time-domain based on the training sequence. The reducer, coupled to the response assesser, is configured to set designated taps associated with the channel impulse response to substantially zero. As a result, a very accurate channel response estimate may be obtained employing less computational complexity in view of substantially removing a noise contribution from designated taps associated with the channel impulse response.

The present invention, therefore, presents a channel estimator that reduces computing requirements and correspondingly reduces memory requirements within an OFDM receiver. Even having a lower computational complexity, the channel estimator provides a channel response estimate equal to or better than conventional channel estimators. The channel estimator may improve a channel response estimate, for instance, by employing a Fast Fourier Transform (FFT) to provide the channel response estimate without a significant performance loss. Additionally, the channel estimator may substantially zero filter coefficients associated with a channel impulse response that mostly contain noise.

The filter coefficients may be taps associated with the discrete-time channel impulse response represented above by equation 4. Typically, a discrete-time model of a channel impulse response does not contain the same number of taps as its continuous-time counterpart because of finite sampling resolution. That is, the time at which each continuous-time tap occurs does not fall directly onto a discrete-time sample. As a result, the energy associated with each misaligned continuous-time tap gets divided between the two adjacent taps in the discrete-time representation, where the energy of the adjacent taps is a function of their temporal distance from the continuous-time tap. In a real system, noise will further smear the discrete-time channel impulse response. The taps corresponding to the real channel impulse response will contain a noise component and there will also be additional taps that correspond to the noise in the system. The channel estimator disclosed herein advantageously reduces the contribution of noise in the discrete-time channel impulse response.

In another aspect, the present invention provides a method of estimating a channel response for use with an OFDM receiver. The method includes receiving a training sequence through the channel, and computing a channel impulse response of the channel based on the training sequence. The method also includes substantially zeroing designated taps associated with the channel impulse response to minimize a noise contribution to the channel response estimate.

The present invention also provides, in yet another aspect, an OFDM receiver including a radio frequency (RF) front end, a data processor and a channel estimator. The RF front end receives a training sequence through a channel and the data processor, coupled to the RF front end, transforms the training sequence to a frequency-domain. The channel estimator includes a response assesser that computes a channel impulse response of the channel in a time-domain based on the training sequence. The channel estimator also includes a reducer, coupled to the response assesser, that sets designated taps associated with the channel impulse response to substantially zero.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of an orthogonal frequency division multiplexing (OFDM) receiver constructed in accordance with the principles of the present invention;

FIG. 2 illustrates a block diagram of an embodiment of a channel estimator constructed in accordance with the principles of the present invention;

FIG. 3 illustrates a graph representing substantially zeroing designated taps in a time-domain block in accordance with the principles of the present invention; and

FIG. 4 illustrates a graph demonstrating a representative performance of an embodiment of a channel estimator constructed in accordance with the principles of the present invention.

### DETAILED DESCRIPTION

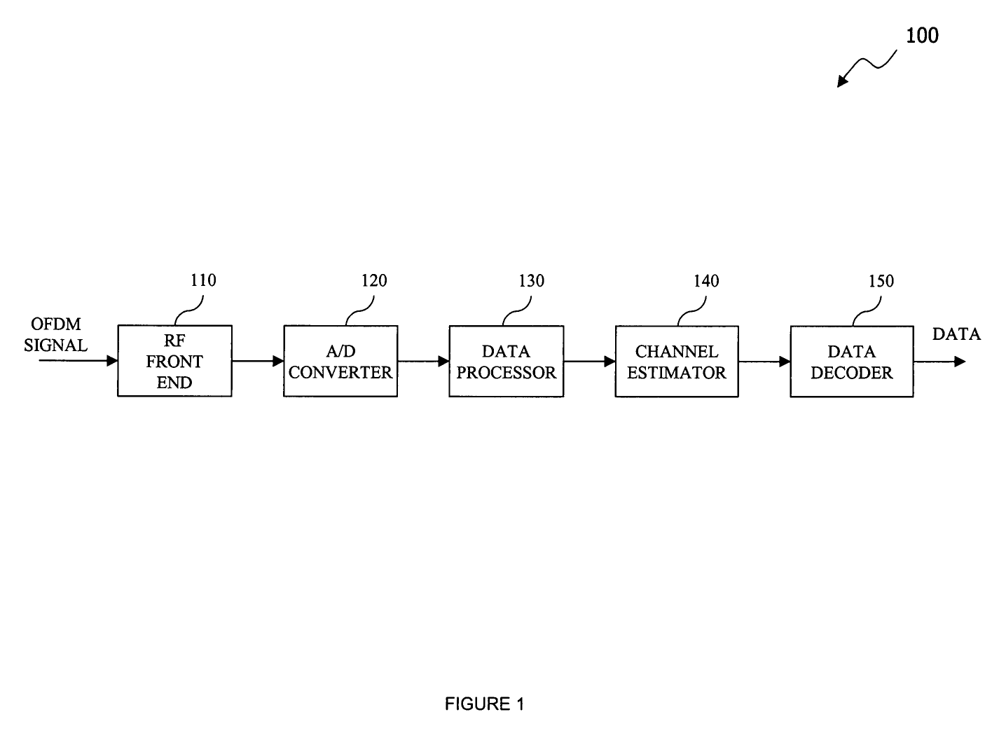

Referring initially to FIG. 1, illustrated is a block diagram of an embodiment of an orthogonal frequency division multiplexing (OFDM) receiver, generally designated 100, constructed in accordance with the principles of the present invention. The OFDM receiver 100 includes a radio frequency (RF) front end 110, an analog-to-digital (A/D) converter 120, a data processor 130, a channel estimator 140 and a data decoder 150. One skilled in the art will also understand that the OFDM receiver 100 may also include additional components that are not shown but may be employed within OFDM compliant receivers.

The OFDM receiver 100 may operate as an Institute of Electrical and Electronic Engineers (IEEE) 802.11(a) compliant receiver. As such, the RF front end 110 may include an antenna that receives an OFDM signal through a wireless channel at frequency bands of, for instance, 2.4 GHz or 5 GHz. Of course, one skilled in the art will understand that the OFDM receiver 100 may operate with other frequency bands. In some embodiments, the RF front end 110 may employ multiple antennas to receive the OFDM signal. For example, the OFDM receiver 100 may operate within a 2×2 system.

The RF front end 110 may include components to amplify and filter the OFDM signal to strengthen a desired signal in the presence of strong unwanted signals associated with the OFDM signal. The desired signal may represent data transmitted to the OFDM receiver 100 from a OFDM transmitter. The RF front end 110, for example, may employ a low noise amplifier and selective filtering to process the desired signal. In some embodiments, the RF front end 110 may also convert the desired signal to an intermediate frequency (IF) signal before further processing. In other embodiments, an IF signal may be obtained digitally. One skilled in the art will understand the configuration and operation of the RF front end 110.

The A/D converter 120 may receive the desired signal from the RF front end 110 and convert the desired signal from an analog domain to a digital domain. The A/D converter 120 may employ conventional A/D converter components and is generally well known and understood in the art. In one embodiment, the A/D converter 120 may operate at 80 MHz with an accuracy of approximately 10-12 bits. After the conversion, the desired signal in the form of a digital data signal may be sent to the data processor 130.

The data processor 130 may convert the desired data signal to a frequency-domain for each carrier of the frequency band. The data processor 130 may include an orthogonal demodulator that extracts in-phase and quadrature-phase components of the desired signal. The in-phase and quadrature-phase components may then be converted to the frequency-domain employing a Fast Fourier Transform (FFT) algorithm. Of course, one skilled in the art will understand that the data processor 130 may perform additional functions such as boundary detection and timing recovery in conjunction with converting signals to the frequency-domain.

The channel estimator 140 may provide a channel response estimate, Ĥ[k], to improve recovery of the data from the desired signal. In addition to the data, the OFDM signal may include a training sequence that the channel estimator 140 employs to provide the channel response estimate. In one embodiment, the training sequence may be an IEEE 802.11 (a) compliant long training sequence.

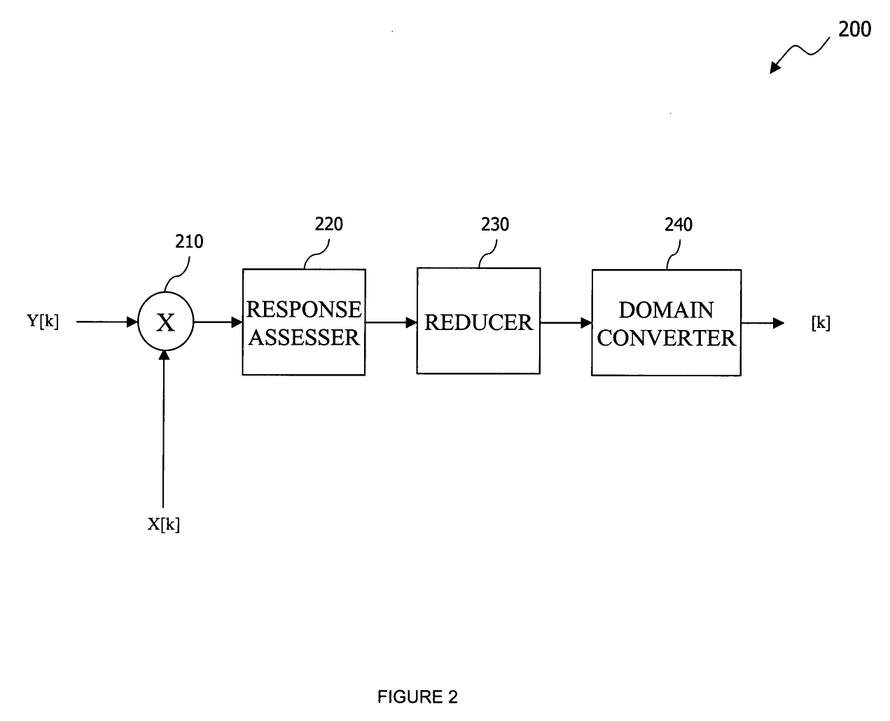

The channel estimator 140 may employ the training sequence to obtain a least squares solution that is further processed with additional computations to provide a channel response estimate having an acceptable level of performance. The channel estimator 140 may be embodied, without limitation, within an Application-Specific Integrated Circuit (ASIC), or in a programmable device such as a Digital Signal Processor (DSP) or a Field Programmable Gate Array (FPGA). In some embodiments, the channel estimator 140 may obtain a modified least squares solution. The channel estimator 140 may include a multiplier, a frequency-to-time-domain converter, a response assessor (which includes a frequency-domain to a time-domain converter), a reducer and a time-to-frequency-domain converter as discussed in more detail with respect to FIG. 2.

The data decoder 150, coupled to the channel estimator 140, may recover the data from the desired signal employing the channel response estimate. In one embodiment, the data decoder 150 may employ a Viterbi algorithm to recover the data. One skilled in the art will understand the operation and configuration of the data decoder 150.

Turning now to FIG. 2, illustrated is a block diagram of an embodiment of a channel estimator, generally designated 200, constructed in accordance with the principles of the present invention. The channel estimator 200 includes a multiplier 210, a response assesser 220, a reducer 230 and a domain converter 240.

The channel estimator 200 may use less computational complexity and provide a better than or equal to channel response estimate that traditionally requires high computational complexity. In a preferred embodiment, the channel estimator 200 may employ a training sequence such as an IEEE 802.11(a) long training sequence, X[k], to provide the channel response estimate. The channel estimator 200 may also employ a 64-point FFT sequence which is a distorted version of the long training sequence due to noise and channel degradation.

The multiplier 210 may employ conventional multiplier components configured to combine two 64-point FFT sequences. The response assesser 220, coupled to the multiplier 210, may be configured to compute a channel impulse response of a channel in a time-domain based on a training sequence. The response assesser 220 may employ conventional components and may employ an inverse Fast Fourier Transform (IFFT) algorithm to transform FFT sequences from the frequency-domain to the time-domain. Similarly, the domain converter 240 may employ conventional components that use a FFT algorithm to transform sequences from the time-domain to the frequency-domain.

The reducer 230, coupled to the response assesser 220, may be configured to set designated taps associated with a channel impulse response to substantially zero. The reducer 230 may substantially zero the designated taps by setting filter coefficients associated with the channel impulse response to zero. The reducer 230 may select the designated taps empirically. The designated taps may be middle taps associated with the channel impulse response. In some embodiments, the designated taps may be approximately equivalent to a number of guard band taps subtracted from a total number of taps associated with the channel impulse response. Additionally, the designated taps may not include end taps associated with the channel impulse response. The designated taps may also be taps having a power level based on a power level of received taps. For example, the designated taps may be taps with a power level at a certain percent, for example, 50% or 25%, of a lowest power level of received taps. The designated taps may also be taps have a certain power level.

In one embodiment of the channel estimator 200, the multiplier 210 may receive the distorted version of the long training sequence from a data processor such as the data processor 130 discussed with respect to FIG. 1. The multiplier 210 may provide a least squares solution by combining the distorted version of the long training sequence with the known long training sequence resulting in a least squares channel response estimate, Ĥ_{LS}[k], represented by equation 5 below. Due to the nature of the long training sequence, a least squares estimate may be taken at 52 non-zero tones located at [−26,−1] and [1,26]. Since the other tones are not excited, a measurement of the channel response may not be obtained at these tones. Thus, the least squares estimate of the channel response may be incomplete at these frequencies:

$${\hat{H}}_{LS} \{ k ] = \frac{Y [ k ]}{X [ k ]} for k ∈ \{ - 26 , - 1 \} and \{ 1 , 26 \} \qquad ( 5 )$$

where Y[k] is the distorted version of the long training sequence and X[k] is the long training sequence.

Since there is little or no information at the DC tone, or zero tone, and at the 11 guard band tones, a linear interpolation of the DC tone may be performed from Ĥ_{LS}[−1] and Ĥ_{LS}[1] as described in the above-referenced co-pending U.S. patent application entitled “TRANSMITTER AND RECEIVER FOR USE WITH AN ORTHOGONAL FREQUENCY DIVISION MULTIPLEXING SYSTEM,” Ser. No. ______. Additionally, since the guard band tones are not excited by the transmitter, the guard band tones may be zeroed and any performance loss associated with zeroing is accepted.

At high signal-to-noise ratios (SNR), for example, greater than 30 dB, zeroing the guard band tones may cause a relatively high error floor. It should be understood, however, that this error is not significant over an operating SNR range of 0-25 dB. Essentially, performance of the channel estimator 200 when zeroing or substantially zeroing the guard bands may be at least comparable with or better than channel estimation methods in this range. Of course, one skilled in the art may employ other methods or techniques to process the DC tones and the guard band tones of the least squares solution in the frequency-domain.

In the frequency-domain, therefore, there may be a rough least squares channel response estimate over 53 tones and zeros in the guard bands. The response assesser 220 may receive the least squares channel response estimate and compute an IFFT of the 64-point FFT sequence to transform it into the time-domain and obtain a channel impulse response. Of course one skilled in the art will understand that a domain converter may transform the 64-point frequency-domain sequence into an equivalent length time-domain sequence before being sent to the response assesser 220 for further processing. The response assesser 220 may sample the 64-point sequence channel impulse response to obtain a sampled version of the channel impulse response, ĥ(n). Based on a model of the channel, middle taps associated with the channel impulse response may have negligible energy when compared to other taps associated with the channel impulse response. The energy of the middle taps may be primarily noise. To minimize the contribution of noise, therefore, to the channel response estimate, the middle taps may be substantially zeroed in accordance with the reducer 230.

Once designated taps associated with the channel impulse response have been substantially zeroed, the domain converter 240 transforms the 64-point sequence channel impulse response, the sampled version of the channel impulse response, back to the frequency-domain employing a FFT algorithm. The resulting channel response estimate Ĥ[k] may then be employed to assist in recovering data.

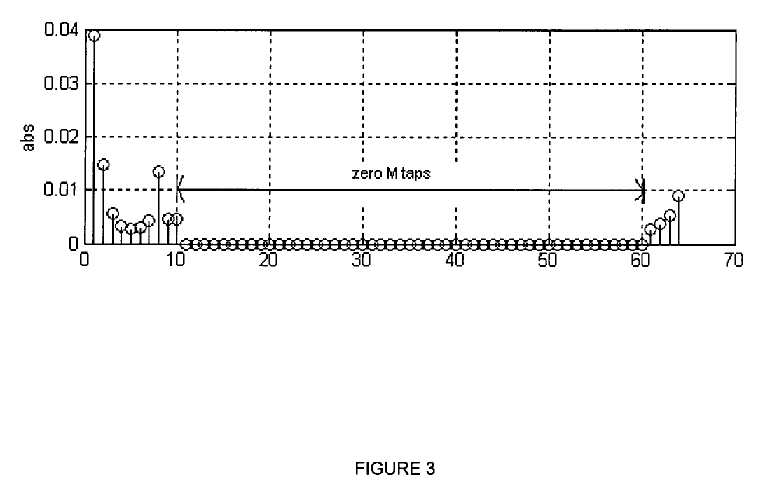

Turning now to FIG. 3, illustrated is a graph representing substantially zeroing designated taps in a time-domain block in accordance with the principles of the present invention. In FIG. 3, the vertical axis is an absolute value of a channel impulse response and the horizontal axis is a number of taps associated with the channel impulse response. As illustrated, a first ten taps may not be designated for zeroing. Of course, one skilled in the art will understand that additional taps may not be designated based on a known environment of a receiver or previous channel impulse responses. In some embodiments, the number of designated taps may be determined in real time. For example, energy measurements may be made and analyzed to determine, on a subchannel basis, a threshold value that may be used to base which taps of the subchannels will be substantially set to zero. For example, tap 5 of FIG. 3, which has a lowest power level compared to other taps, may be used to determine the threshold value. The threshold value may be at a certain percentage, for example, 50% or 25%, of the power level of tap 5. Additionally, the threshold value may also be a defined power level. Referring to FIG. 3 for example, the designated taps may be taps having a power level less than or equal to a threshold value of 0.005 an absolute value of a channel impulse response. In this respect, the threshold value may be a set power level typically less than the lowest power level that is received.

The number of non-zeroed taps, N-M, where N represents a total number of taps associated with the channel impulse response and M represents the middle taps, may be approximately equivalent to the number of taps associated with the guard band i.e., the length of a cyclic prefix. With a long training sequence, the total number of taps N may equal 64. In one embodiment, some taps located approximate to an end of the total number of taps are not zeroed. Typically, if a non-sample spaced tap is close to zero, which corresponds to a line-of-sight path, then a side lobe from a band-limited interpolation will show up cyclically repeated at the end of the long training sequence. Naively truncating energy associated with this side lobe may result in a high error floor. Therefore, to reduce this error floor possibly seen in high SNR ranges, a last few samples of the channel impulse response, or end taps associated with the channel impulse response, may not be zeroed.

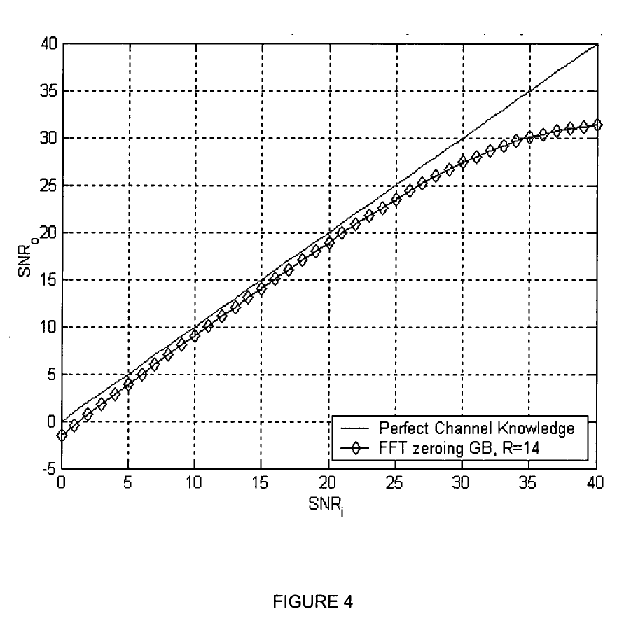

Turning now to FIG. 4, illustrated is a graph demonstrating a representative performance of an embodiment of a channel estimator constructed in accordance with the principles of the present invention. FIG. 4 reflects estimating a DC tone as described in the above-referenced co-pending U.S. patent application. The performance is measured using a floating-point Matrix Laboratory (MATLAB) simulation. The degradation from perfect channel knowledge was measured using an output SNR as a metric. An input SNR, without channel distortion is given by equation 6.

$${SNR}_{i} = \frac{{σ}_{s}^{2}}{{σ}_{n}^{2}} \qquad ( 6 )$$

The output SNR is a resultant SNR at the output due to channel estimation error and is given by equation 7:

$${SNR}_{0} = \frac{{σ}_{s}^{2}}{{σ}_{n}^{2} + {σ}_{c}^{2} ( {σ}_{s}^{2} + {σ}_{n}^{2} )} \qquad ( 7 )$$

where σ_{c} is a variance of the channel error, normalized for the channel over the 52 tones in which data is transmitted. Assuming that the channel error is zero mean, the expression for the variance of the channel error σ_{c} may be represented by equation 8.

$${σ}_{c}^{2} = \frac{1}{N} \frac{1}{52} {\sum }_{i = 1}^{N} {\sum }_{k ∈ 52 tones} \frac{{( {H}_{i} [ k ] - {H}_{i} [ k ] )}^{2}}{{( {H}_{i} [ k ] )}^{2}} \qquad ( 8 )$$

With perfect channel knowledge, SNRᵢ=SNRₒ. In general, however, SNRₒ<SNRᵢ.

The input SNR, SNRᵢ, versus the output SNR, SNRₒ, is plotted for a channel estimator to assess its performance. The results are shown averaged over many multi-path channels. Note that the channel estimator has exceptionally good performance in the SNR range from 0-25 dB. The error due to zeroing the guard band may become noticeable after 30 dB. Thus, performance in this region may decrease.

In summary, the present invention provides embodiments of an OFDM receiver, a channel estimator and a method of obtaining a channel response estimate. An advantage of the invention includes decreasing computational complexity by substantially zeroing (e.g., zeroing) designated taps associated with the channel impulse response to reduce a noise contribution when obtaining a channel response estimate.

Although the present invention has been described in detail, those skilled in the art should understand that they can make various changes, substitutions and alterations herein without departing from the spirit and scope of the invention in its broadest form.

1. For use with an orthogonal frequency division multiplexing (OFDM) receiver, a channel estimator employing a training sequence received through a channel, comprising:
a response assesser configured to compute a channel impulse response of said channel in a time-domain based on said training sequence; and
a reducer, coupled to said response assesser, configured to set designated taps associated with said channel impulse response to substantially zero.

2. The channel estimator as recited in claim 1 wherein said designated taps are middle taps associated with said channel impulse response.

3. The channel estimator as recited in claim 1 wherein said designated taps are approximately equivalent to a number of guard band taps subtracted from a total number of taps associated with said channel impulse response.

4. The channel estimator as recited in claim 1 wherein said designated taps have a power level based on a threshold value.

5. The channel estimator as recited in claim 1 wherein said designated taps are selected empirically.

6. The channel estimator as recited in claim 1 wherein said designated taps do not include end taps associated with said channel impulse response.

7. The channel estimator as recited in claim 1 wherein said training sequence is an Institute of Electrical and Electronic Engineers (IEEE) 802.11 compliant long training sequence.

8. For use with an orthogonal frequency division multiplexing (OFDM) receiver, a method of obtaining a channel response estimate, comprising:
receiving a training sequence through said channel;
computing a channel impulse response of said channel based on said training sequence; and
substantially zeroing designated taps associated with said channel impulse response to minimize a noise contribution to a channel response estimate.

9. The method as recited in claim 8 wherein said designated taps are middle taps associated with said channel impulse response.

10. The method as recited in claim 8 wherein said designated taps are approximately equivalent to a number of guard band taps subtracted from a total number of taps associated with said channel impulse response.

11. The method as recited in claim 8 wherein said designated taps have a power level based on a threshold value.

12. The method as recited in claim 8 further comprising selecting said designated taps empirically.

13. The method as recited in claim 8 further comprising selecting said designated taps such that end taps associated with said channel impulse response are excluded.

14. The method as recited in claim 8 wherein said training sequence is an Institute of Electrical and Electronic Engineers (IEEE) 802.11 compliant long training sequence.

15. An orthogonal frequency division multiplexing (OFDM) receiver, comprising:
a radio frequency (RF) front end that receives a training sequence through a channel;
a data processor, coupled to said RF front end, that transforms said training sequence to a frequency-domain; and
a channel estimator, including:
a response assesser that computes a channel impulse response of said channel in a time-domain based on said training sequence; and
a reducer, coupled to said response assesser, that sets designated taps associated with said channel impulse response to substantially zero.

16. The OFDM receiver as recited in claim 15 wherein said designated taps are middle taps associated with said channel impulse response.

17. The OFDM receiver as recited in claim 15 wherein said designated taps are approximately equivalent to a number of guard band taps subtracted from a total number of taps associated with said channel impulse response.

18. The OFDM receiver as recited in claim 15 wherein said designated taps have a power level based on a threshold value.

19. The OFDM receiver as recited in claim 15 wherein said designated taps are selected empirically.

20. The OFDM receiver as recited in claim 15 wherein said designated taps do not include end taps associated with said channel impulse response.

21. The OFDM receiver as recited in claim 15 wherein said training sequence is an Institute of Electrical and Electronic Engineers (IEEE) 802.11 compliant long training sequence.
